(19) United States
(12) Patent Application Publication
(10) Pub. No.: US 2026/0371126 A1
(43) Pub. Date: Nov. 19, 2026

(54) METHOD FOR DOPPLER INFORMATION REPORTING

(71) Applicant: Nokia Technologies Oy, Espoo (FI)

(72) Inventors: Juha Pekka KARJALAINEN, Sotkamo (FI); Bikshapathi GOUDA, Oulu (FI); Sami-Jukka HAKOLA, Kempele (FI); Timo KOSKELA, Oulu (FI); Antti ARVOLA, Oulu (FI); Italo ATZENI, Oulu (FI); Antti TÖLLI, Oulu (FI); Filippo TOSATO, Bures sur Yvette (FR)

(21) Appl. No.: 19/103,252

(22) PCT Filed: May 22, 2023
(86) PCT No.: PCT/EP2023/063558

§ 371 Date: Feb. 12, 2025

(30) Foreign Application Priority Data
Aug. 12, 2022 (FI) 20225719

(51) Int. Cl. H04W 24/10; H04L 5/00

(52) U.S. Cl. CPC H04W 24/10; H04L 5/0035; H04L 5/005

(57) ABSTRACT

An apparatus comprising: means for receiving, from a network, a tracking reference signal configuration, the configuration comprising at least one parameter to be measured and at least one validity condition related to the at least one parameter to be measured; means for performing, using the configuration, at least one measurement of the at least one parameter, the at least one parameter related to a tracking reference signal; means for determining whether at least one validity condition associated with the at least one measurement is valid; and means for reporting, to the network, the at least one measurement of the at least one parameter, and the determination of whether the at least one validity condition is valid.

### TECHNICAL FIELD

The examples and non-limiting example embodiments relate generally to communications and, more particularly, to a method for Doppler information reporting.

### BACKGROUND

It is known to perform Doppler measurements in a wireless communication network.

### SUMMARY

In accordance with an aspect, an apparatus includes means for receiving, from a network, a tracking reference signal configuration, the configuration comprising at least one parameter to be measured and at least one validity condition related to the at least one parameter to be measured; means for performing, using the configuration, at least one measurement of the at least one parameter, the at least one parameter related to a tracking reference signal; means for determining whether at least one validity condition associated with the at least one measurement is valid; and means for reporting, to the network, the at least one measurement of the at least one parameter, and the determination of whether the at least one validity condition is valid.

In accordance with an aspect, an apparatus includes means for transmitting, to a user equipment, a tracking reference signal configuration, the configuration comprising at least one parameter to be measured and at least one validity condition related to the at least one parameter to be measured; means for receiving, from the user equipment, a report comprising the at least one measurement of the at least one parameter, the at least one parameter related to a tracking reference signal, and a determination of whether the at least one validity condition is valid; and means for transmitting, to at least one transmission reception point using a backhaul link, the at least one measurement and the determination of whether the at least one validity condition is valid.

In accordance with an aspect, a method includes receiving, from a network, a tracking reference signal configuration, the configuration comprising at least one parameter to be measured and at least one validity condition related to the at least one parameter to be measured; performing, using the configuration, at least one measurement of the at least one parameter, the at least one parameter related to a tracking reference signal; determining whether at least one validity condition associated with the at least one measurement is valid; and reporting, to the network, the at least one measurement of the at least one parameter, and the determination of whether the at least one validity condition is valid.

In accordance with an aspect, a method includes transmitting, to a user equipment, a tracking reference signal configuration, the configuration comprising at least one parameter to be measured and at least one validity condition related to the at least one parameter to be measured; receiving, from the user equipment, a report comprising the at least one measurement of the at least one parameter, the at least one parameter related to a tracking reference signal, and a determination of whether the at least one validity condition is valid; and transmitting, to at least one transmission reception point using a backhaul link, the at least one measurement and the determination of whether the at least one validity condition is valid.

In accordance with an aspect, an apparatus includes at least one processor; and at least one memory including computer program code; wherein the at least one memory and the computer program code are configured to, with the at least one processor, cause the apparatus at least to: receive, from a network, a tracking reference signal configuration, the configuration comprising at least one parameter to be measured and at least one validity condition related to the at least one parameter to be measured; perform, using the configuration, at least one measurement of the at least one parameter, the at least one parameter related to a tracking reference signal; determine whether at least one validity condition associated with the at least one measurement is valid; and report, to the network, the at least one measurement of the at least one parameter, and the determination of whether the at least one validity condition is valid.

In accordance with an aspect, an apparatus includes at least one processor; and at least one memory including computer program code; wherein the at least one memory and the computer program code are configured to, with the at least one processor, cause the apparatus at least to: transmit, to a user equipment, a tracking reference signal configuration, the configuration comprising at least one parameter to be measured and at least one validity condition related to the at least one parameter to be measured; receive, from the user equipment, a report comprising the at least one measurement of the at least one parameter, the at least one parameter related to a tracking reference signal, and a determination of whether the at least one validity condition is valid; and transmit, to at least one transmission reception point using a backhaul link, the at least one measurement and the determination of whether the at least one validity condition is valid.

In accordance with an aspect, a non-transitory program storage device readable by a machine, tangibly embodying a program of instructions executable with the machine for performing operations is provided, the operations comprising: receiving, from a network, a tracking reference signal configuration, the configuration comprising at least one parameter to be measured and at least one validity condition related to the at least one parameter to be measured; performing, using the configuration, at least one measurement of the at least one parameter, the at least one parameter related to a tracking reference signal; determining whether at least one validity condition associated with the at least one measurement is valid; and reporting, to the network, the at least one measurement of the at least one parameter, and the determination of whether the at least one validity condition is valid.

In accordance with an aspect, a non-transitory program storage device readable by a machine, tangibly embodying a program of instructions executable with the machine for performing operations is provided, the operations comprising: transmitting, to a user equipment, a tracking reference signal configuration, the configuration comprising at least one parameter to be measured and at least one validity condition related to the at least one parameter to be measured; receiving, from the user equipment, a report comprising the at least one measurement of the at least one parameter, the at least one parameter related to a tracking reference signal, and a determination of whether the at least one validity condition is valid; and transmitting, to at least one transmission reception point using a backhaul link, the at least one measurement and the determination of whether the at least one validity condition is valid.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 depicts an example of DL TRS for OFDM in NR Rel-15.

FIG. 3 shows use of NZP CSI-RS symbols to measure the Doppler information at a UE.

FIG. 4 depicts Doppler estimation based on UL SRS.

FIG. 5 shows signaling of a UE based Doppler estimation and correction method, based on the examples described herein.

FIG. 6 is an example apparatus configured to implement the examples described herein.

FIG. 7 shows a representation of an example of non-volatile memory media.

FIG. 8 is a method to perform the examples described herein.

FIG. 9 is a method to perform the examples described herein.

### DETAILED DESCRIPTION OF EXAMPLE EMBODIMENTS

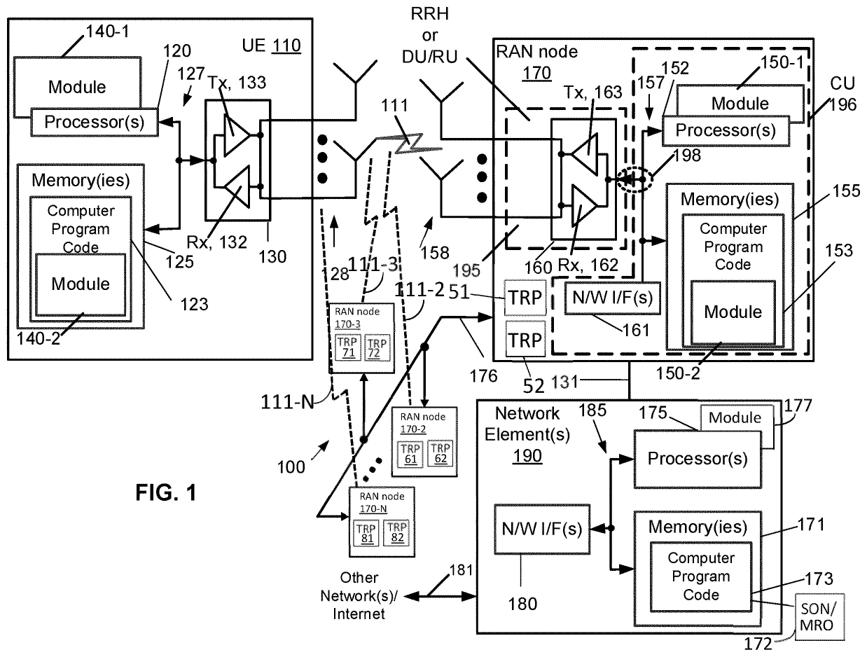

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station, access point, access node or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memory(ies) 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

As shown in FIG. 1, RAN node 170 may communication with RAN node 170-2, RAN node 170-3, and RAN node 170-N using link 176. The UE 110 communicates with RAN node 170-2 via a wireless link 111-2, the UE 110 communicates with RAN node 170-3 via a wireless link 111-3, and the UE 110 communicates with RAN node 170-N via a wireless link 111-N. RAN node 170-2 includes TRP 61 and TRP 62, RAN node 170-3 includes TRP 71 and TRP 72, and RAN node 170-N includes TRP 81 and TRP 82. Each of RAN node 170, 170-2, 170-3, and 170-N can comprise more than two TRPs.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more TRPs to which the methods described herein may be applied. FIG. 1 shows that the RAN node 170 comprises two TRPs, TRP 51 and TRP 52. The RAN node 170 may host or comprise other TRPs not shown in FIG. 1. The TRPs 51 and 52 may form part of the components of transceiver 160.

Within this disclosure, two TRPs can be for one gNB (e.g. serving cell) and another two TRPs can be for another cell/gNB (different PCI than the serving cell). Alternatively, all the TRPs can be associated with the same cell. Thus the TRPs as described herein may be associated with the same or different PCIs.

A relay node in NR is called an integrated access and backhaul node. A mobile termination part of the IAB node facilitates the backhaul (parent link) connection. The mobile termination part is the functionality which carries UE functionalities. The distributed unit part of the IAB node facilitates the so called access link (child link) connections (i.e. for access link UEs, and backhaul for other IAB nodes, in the case of multi-hop IAB). The distributed unit part is responsible for certain base station functionalities. The IAB scenario may follow a split architecture, where the central unit hosts the higher layer protocols to the UE and terminates the control plane and user plane interfaces to the 5G core network.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. Such core network functionality may include SON (self-organizing/optimizing network) functionality. These are merely example functions that may be supported by the network element(s) 190, and both 5G and LTE functions may be supported. The RAN node 170 is coupled via a link 131 to the network element 190. The link 131 may be implemented as, e.g., an NG interface for 5G, or an SI interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or MRO functionality 172.

The one or more network elements 190 comprises a module 177 that may include Near-Real-Time RIC functionality. Computer program code 173 may include Near-Real-Time RIC functionality. Module 150-1 and/or module 150-2 may include Near-Real-Time RIC functionality.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein. In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g. a drone, or a UE mounted in a UAV.

UE 110, RAN node 170, and/or network element(s) 190, (and associated memories, computer program code and modules) may be configured to implement (e.g. in part) the methods described herein, including a method for Doppler information reporting. Thus, computer program code 123, module 140-1, module 140-2, and other elements/features shown in FIG. 1 of UE 110 may implement user equipment related aspects of the methods described herein. Computer program code 153, module 150-1, module 150-2, and other elements/features shown in FIG. 1 of RAN node 170 may implement gNB/TRP related aspects of the methods described herein. Computer program code 173 and other elements/features shown in FIG. 1 of network element(s) 190 may be configured to implement network element related aspects of the methods described herein.

Having thus introduced a suitable but non-limiting technical context for the practice of the example embodiments, the example embodiments are now described with greater specificity. The examples described herein relate to the PHY layer enhancements considering MIMO related environments enabling Doppler shifts/spreads/measurements. Particular components are implemented by UEs and gNBs. The methods described herein are related to Rel. 17 HST-SFN enhancements (e.g. R1-2101450 and R1-2202320) for UE-based Doppler measurement reporting (especially an explicit approach). Refer also to RP-213517, RP-213598, R1-2204143. The examples described herein relate to validity conditions for Doppler parameter measurements, including default and fallback reporting modes. In particular, described herein are conditions for validity (e.g. power threshold or offsets) of TRP-specific and inter-TRP Doppler parameter measurements and the corresponding reporting. The examples described herein provide further accuracy and reliability.

Standardization for Rel-18 puts focus on the enhancements of uplink (UL) MIMO, while the necessary enhancements on downlink (DL) MIMO that facilitate the use of large antenna arrays (not only for FR1 but also for FR2) still need to be introduced to fulfill the request for evolution of NR deployments [Tdoc number RP-213517—‘New WID: MIMO Evolution for Downlink and Uplink’].

Rel-16/17 MIMO provides support for multi-TRP deployments in the form of non-coherent joint transmission (NC-JT). Moreover, coherent joint transmission (CJT), introduced in Rel-11 for LTE, can improve the coverage and average throughput in commercial deployments with high-performance backhaul and synchronization. With this in mind, enhancement on CSI acquisition for FDD and TDD, targeting FR1, can be beneficial in expanding the utility of CJT to NR multi-TRP deployments [Tdoc number RP-213517—‘New WID: MIMO Evolution for Downlink and Uplink’]. Consequently, CJT is considered as one of the potential technologies in 5G-advanced cellular systems targeting Rel- 18. In CJT, multiple TRPs serve each UE in a coherent manner, which allows to greatly improve the throughput of the cell-edge UEs. However, CJT requires accurate channel state information (CSI), e.g., ‘phase, timing, frequency’ synchronization for successful operation. For example, any phase changes in the CSI may lead to the destructive combining at the target UE and, as a result, the SINR of the UE decreases (and so does the throughput).

Considering a moving UE, the impact of the Doppler shift/spread is one of the reasons for different phase changes in the channel from multiple TRPs. The velocity of the UE is different, respective to multiple TRPs, and consequently the channel from each TRP to the UE is impacted by the resulting Doppler shift/spread. For CJT-COMP (coordinated multi-point), this causes interference at the UE, subsequently degrading the throughput.

NR Rel-15 supports coarse downlink time and frequency synchronization based on secondary synchronization signals and primary synchronization signals located in a synchronization signal block (SSB). After SSB reception, the UE is intended to compensate a residual time and frequency error offset as well as to adjust the parameters of a DMRS channel estimator, i.e. Wiener filter length in time and frequency to match with the coherence time and the frequency of a radio channel, with a time and frequency tracking reference signal (TRS).

As mentioned above, NR Rel-15 provides a mechanism to support downlink TRS transmission by using NZP-CSI-RS resources with a CP-OFDM waveform [TS 38.211]. In TS 38.214, two different NZP-CSI-RS resource set configurations are supported for the UE to perform time-and frequency tracking. More specifically, according to [TS 38.214], for a NZP-CSI-RS-ResourceSet configured with the higher layer parameter trs-Info, the UE is to assume the antenna port with the same port index of the configured NZP CSI-RS resources in the NZP-CSI-RS-ResourceSet is the same.

For frequency range 1 (i.e., below 6 GHz), the UE may be configured with one or more NZP CSI-RS set(s), where a NZP-CSI-RS-ResourceSet consists of four periodic NZP CSI-RS resources in two consecutive slots with two periodic NZP CSI-RS resources in each slot.

For frequency range 2 (i.e., above 6 GHz) the UE may be configured with one or more NZP CSI-RS set(s), where a NZP-CSI-RS-ResourceSet consists of two periodic CSI-RS resources in one slot or with a NZP-CSI-RS-ResourceSet of four periodic NZP CSI-RS resources in two consecutive slots with two periodic NZP CSI-RS resources in each slot.

The UE expects that the periodic CSI-RS resource set and aperiodic CSI-RS resource set are configured with the same number of CSI-RS resources and with the same number of CSI-RS resources in a slot. For the aperiodic CSI-RS resource set if triggered, and if the associated periodic CSI-RS resource set is configured with four periodic CSI-RS resources with two consecutive slots with two periodic CSI-RS resources in each slot, the higher layer parameter aperiodicTriggeringOffset indicates the triggering offset for the first slot for the first two CSI-RS resources in the set.

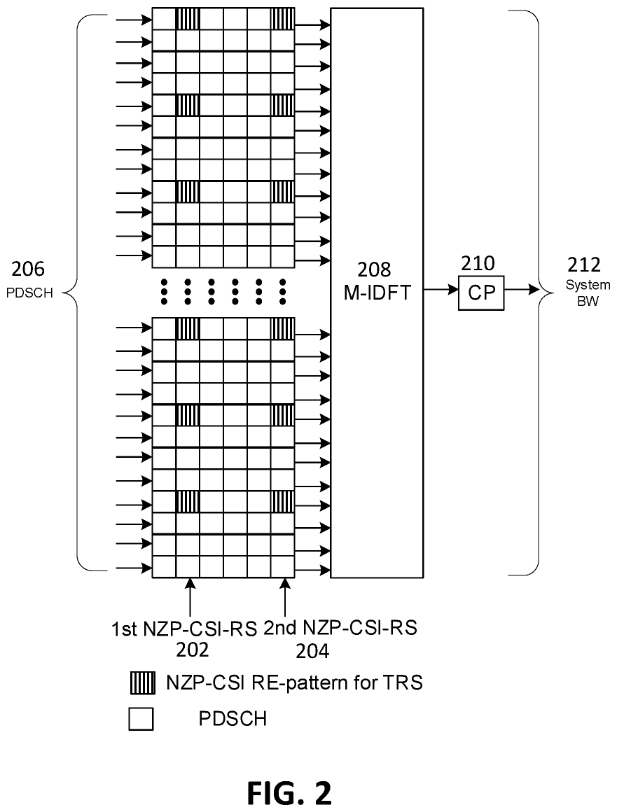

FIG. 2 shows an example of CP-OFDM based DL NZP-CSI-RS based TRS transmission in NR Rel-15. As shown, the NZP CSI-RS resource is a single port with density 3. The maximum bandwidth of CSI-RS resources is 52 physical resource blocks (PRB)s. The time domain location of the two CSI-RS resources in a slot, or of the four CSI-RS resources in two consecutive slots is given by one of the following [TS 38.214]:
{4,8}, {5,9} or {6,10} for frequency range 1 and FR2,
{0,4}, {1,5}, {2,6}, {3,7}, {7,11}, {8,12} or {9,13} for FR2.

As shown in FIG. 2, the first NZP-CSI-RS 202 and the second NZP-CSI-RS 204 are within PDSCH 206. An M-IDFT 208 is applied to the PDSCH 206. CP 210 is applied to the output of the M-IDFT 208. System BW 212 is impacted by the process and configuration shown in FIG. 2.

The Rel-17 NR specification provides support for both network and Rel-15 UE based Doppler shift/spread tracking, described earlier. In the network-based approach, used in the high-speed train HST scenario where the DL PDSCH is transmitted in a single frequency network (SFN) manner from multiple TRPs after compensating for Doppler based on uplink measurements. Further details are described herein.

NR Rel-18 is to specify CSI reporting enhancement for high/medium UE velocities by exploiting time-domain correlation/Doppler-domain information to assist DL precoding (targeting FR1) as follows [Tdoc number RP-213517—‘New WID: MIMO Evolution for Downlink and Uplink’]:
Rel-16/17 Type-II codebook refinement, without modification to the spatial and frequency domain basis
UE reporting of time-domain channel properties measured via CSI-RS for tracking.

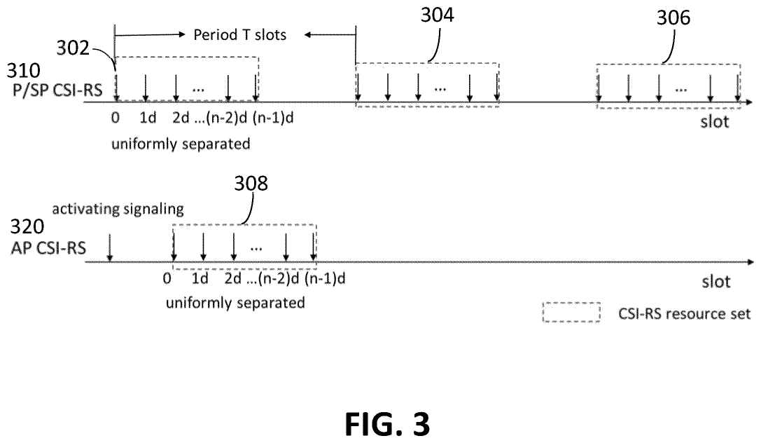

Based on the proposal in [Tdoc number R1-2203151—‘New WID: CSI enhancement for coherent JT and mobility’], the UE can measure the Doppler information from the set of uniformly separated NZP CSI-RS bursts as in FIG. 3. The burst of NZP CSI-RS helps to estimate more accurate and reliable Doppler information at the UE.

Shown in FIG. 3 are CSI-RS resource sets (302, 304, 306) for P/SP CSI-RS 310, and a CSI-RS resource set 308 for AP CSI-RS 320, with each of the CSI-RS resource sets (302, 304, 306, 308) comprising uniformly separated NZP CSI-RS bursts, where at least for CSI-RS resource sets 302 and 308, the NZP CSI-RS bursts are separated by a 1 d time slot for a given time period d.

The extracted Doppler information from the UE can be used at the gNB to enhance the downlink throughput, where the use cases are as follows [Tdoc number R1-2203229—‘New WID: On CSI enhancements for Rel-18 NR MIMO evolution’]:
Using the UE report, the network may determine the periodicity for configuration or time for triggering of CSI-RS, a CSI report or SRS.
Using the UE report, the network determines whether to configure a Type I or Type II CSI report.
Using the UE report, the network can determine whether to use reciprocity-based CSI acquisition or type II-based CSI feedback for MU-MIMO scheduling.
Using the UE report, the network can determine the number of additional DMRS symbols needed.
The network uses the report as an input to open loop link adaptation algorithms to adjust the selection of robust MCS, also for URLLC cases.
The network uses the report as an input to an AI/ML algorithm in the higher layers of the network or for beam management.

To achieve merits of coherent joint transmission with precoding for TDD based DL multi-TRP operation in NR Rel-18 and beyond releases (i.e. enhancements in inter-cell and MU-MIMO interference mitigation and spectral efficiency), availability of accurate DL CSI information plays an important role in this process. In practice, due to mobility of the UE, it may be challenging to obtain up to date DL CSI information via UL SRS sounding or DL CSI reporting based on DL RS measurements. In fact, time delays always exists between UL/DL CSI measurement (and estimation) time occasion and the time instant when joint precoding among different TRPs is to be applied. There are also some other potential sources for CSI inaccuracy such as estimation errors, latencies associated with backhauling and quantization of reported CSI information. To tackle some of the impacts, the time domain prediction of CSI information at the network side based on the UE Doppler information measurements and reporting can be seen as one attractive candidate for Rel-18 DL multi-TRP CJT and beyond releases.

The problem of radio channel time evolution tracking was addressed in the high-speed train (HST) scenario, where a dominant LoS propagation path always exists and only Doppler shift needs to be tracked for each of TX-RX pairs between the TRP and the UE. As discussed earlier, Rel-17 provides support for both the UE and the network-based approach for SFN HST scenarios, including networks utilizing UL SRS transmission with Doppler shift precompensation at the network side. A main focus of the examples described herein is set on the network based approach.

The problem of the Rel-17 network based approach is that the Doppler estimation at each TRP requires multiple UL SRS transmissions from a single UE. As a result of this, UL SRS resource overhead increases drastically causing degradation to UL PUSCH throughput. Additionally, due to limited UL TX power, the quality of Doppler information estimates based on UL SRS transmission may be significantly degraded in some scenarios, e.g. when the UE is located at edge of serving coverage of the TRP.

To enhance the network-based pre-compensation approach by reducing the UL SRS overhead and latency, to increase the reliability of the measurements and to enhance the network efficiency there is a need to develop new methods for Doppler information measurements and reporting based on DL TRS measurements.

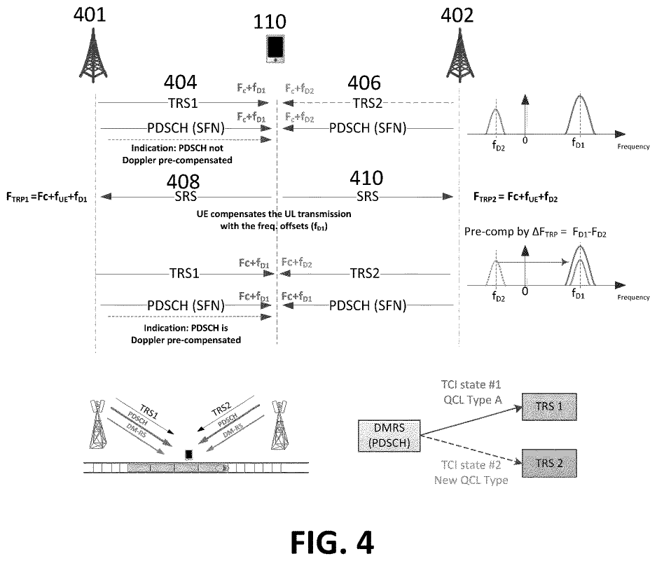

FIG. 4 depicts Doppler estimation based on UL SRS. FIG. 4 is based partially on Tdoc number RP-213517—‘New WID: MIMO Evolution for Downlink and Uplink’.

The Doppler estimation for the HST scenario is described in [Tdoc number R1-2101450—‘Enhancements on HST-SFN deployment’R4], where the Doppler shift can be estimated using the UL SRS. This is shown in FIG. 4 for the case of two TRPs (401, 402). Initially, TRS1 404 and TRS 2 406 are transmitted from TRP1 401 and TRP2 402, respectively, then the UE 110 measures ‘fD1’ associated with TRS1 404 and compensates it in the UL. At this stage, the UE 110 sends the UL SRS (408, 410) at ‘Fc+fUE’, which is received by TRP1 401 at ‘Fc+fUE+fD1’ and by TRP2 402 at ‘Fc+fUE+fD2’. The difference in Doppler shifts between TRP1 401 and TRP2 402 can be calculated using backhaul signaling and pre-compensated while sending the data.

However, in some scenarios, the UL SRS transmission 408 intended for TRP1 401 may suffer from the limited UL TX power budget of the UE 110, resulting in larger estimation errors e.g. related to Doppler shifts, CSI, etc. In this regard, the number of different SRS transmissions associated with different TRPs needs to be increased as mentioned in [Tdoc number R1-2202320—‘Maintenance of Enhancements for HST-SFN deployment’]. For example, to estimate small Doppler shifts UL SRS transmission occasions need to be configured over several symbols/slots. It is worth noting that the coherence time of a radio scales roughly inversely with respect to Doppler spread/shift. This may induce the extra latency as well as UL reference signal resource overhead as well as potential scheduling restrictions leading to reduced UL data throughput. In [Tdoc number R1-2101450—‘Enhancements on HST-SFN deployment’], an alternative approach is defined where Doppler parameters are determined at the UE-side by performing measurements on TRS reference signal transmission and reporting them back to the network.

Accordingly, described herein are the validity conditions for Doppler parameter measurements and the corresponding reporting. Moreover, described herein are methods for both default and fall-back Doppler information reporting modes.

The compliance for the Doppler estimation at the UE and the UE reporting mechanism of the Doppler parameters (enhanced CSI parameters) are summarized as follows.

The following assumptions are made. The network can configure via higher layer signalling (i.e., RRC) one or more TRS resource sets to work as an “anchor” resource (used in Doppler difference computation). The network can configure via higher layer signalling the K_{TRP#}-strongest/dominant multi-path components associated with each TRP specific TRS resources to be measured. The network can provide determination parameters (such as received power threshold levels, measurement time window, aging information, reporting time offset, maximum delay spread of a TRP specific link, max propagation delay or delay spread of each TRS) to the UE, so that UE validates the K_{TRP#}-strongest/dominant multi-path components associated with each TRP specific TRS resources. The network can configure different standalone Doppler parameter/information reporting formats. In this context, standalone means that the report does not depend on other codebook-based CSI reporting. Alternatively, the network may also configure non-standalone Doppler parameter/information reporting formats. The reporting formats can include TRP specific Doppler information (i.e. difference between Doppler shifts and/or plain Doppler shifts and/or difference between phases and/or plane phase and/or Doppler spread) and/or inter-TRP Doppler information. The network can configure the reporting format of time of arrival of the first multipath component associated with each configured TRS resource and each multipath component of a configured TRS resource. The network can configure the Doppler reporting time offset.

A primary target of standalone or non-standalone Doppler information reporting is to aid the gNB, for example, in scheduling the periodicity of CSI-RS resources and CSI reporting and the choice of type of reporting (including the choice between mTRP CSI reporting, such as Type-I NCJT and Type-II CJT, and sTRP CSI reporting). Furthermore, Doppler information reporting can be used to aid gNB-side prediction e.g. for DL precoding. This can be beneficial for both CSI feedback based precoding schemes and UL SRSs reciprocity based precoding schemes. Both standalone and non-standalone Doppler information reporting can be used in the context of single and multi-TRP scenarios.

The validity of TRP specific and inter-TRP Doppler information measurements (for one or more parameters) and reporting are defined as follows. Doppler information (e.g. an item of Doppler information) can be defined to be as either multi-path specific Doppler shift or a multipath specific Doppler shift difference between resources (e.g. TRS) associated with an “anchor” TRP and another TRP (sharing the same or different physical cell ID (PCI)). Validity of Doppler parameter measurements can be defined based on, for example, one of the following conditions: Condition#1, based on a TRP specific or inter-TRP multi-path power difference between K_{TRP#} dominant multi-path components; Condition#2, based on a TRP-specific or inter-TRP TRS resource application time for a Doppler difference computation; Condition#3, based on a TRP-specific or inter-TRP difference in measurement time for a Doppler difference computation; Condition#4, based on the time of arrival computation of each TRP specific TRS; or Condition#5, based on the reporting time offset.

Accordingly, new methods for Doppler information reporting with default and fallback reporting modes are described. The default operations mode is used if all or configured validity conditions are met, and the fallback operation mode is used if at least one of the configured validity conditions is not met.

In the default operations mode (if all or configured validity conditions are met), the UE 110 reports, using a new CSI format, parameters related to the Doppler shift/spread and/or a number of one or more TRP-specific TRSs used for measurements.

In the fallback operation mode (if at least one of the configured validity conditions is not met) the UE 110 reports at least one of a set of fallback parameters such as Doppler shift/spread values, an indication of the Doppler reporting format, an indication of the anchor resource set (if required), an indication of the number of valid paths measured, an indication of the number of valid TRS resources used for measurement, an indication of the aging validity for the measurement, time difference between the TRS resources, time difference of arrival of each multipath, and anchor resource time difference with respect to the slot timing.

Initially the network configures the Doppler reference signal (e.g. TRS) or signal (e.g. SSB) resource and parameters to be measured (or validated) at the UE using a downlink control signalling framework (e.g. via RRC and/or physical and/or MAC level signalling). Then, TRPs transmit the NZP-CSI-RS in the DL, and the UE performs the Doppler measurements as requested by the network along with the validity of the measurements. Once the UE completes the computation of the Doppler parameters, the UE reports the Doppler information along with the configured validity conditions.

The network configures the UE with the predefined set of compliance to measure the Doppler parameters. For this it is assumed that the network configures the following parameters.

The network configures one or more TRS resource sets to work as an ‘anchor’ resource to compute the Doppler differences.

The network configures the K_{TRP#}-strongest/dominant multi-path components associated with each TRP specific TRS resources to be measured. The UE computes and selects the K_{TRP#}-strongest multipath components of each of the TRP specific TRS resources. A power threshold is defined, or a relative power difference with respect to the first detected multi-path component is defined, to determine the K_{TRP#}-strongest multipath components associated with each one-antenna port TRS resource. A default assumption is that an equal number of multipath components for each of the TRP specific TRS resources is used.

The network configures the CSI/Doppler information related to the time (or age) of measurements or measurement occasions. The aging information is configured by the network, based on the channel conditions, and based on when the measurement is going to be applied in the DL relative to the time of measurement. The network configures for the UE an aging validity condition, e.g. P-consecutive TRS transmission occasions over which the UE shall perform measurement based on which it shall provide also a corresponding report. By doing this, network can impose a measurement restriction for the UE such that the UE is forced to use certain TRS measurement occasions for the specific reporting instance. As a result of this, the gNB can be ensured that these measurements are really associated for a certain time window and not for measurement accumulated over an undefined period. This can be useful for example, if some periodic TRS resources are configured which are then complemented with aperiodic TRS resources. The delay spread of each TRP specific TRS resource can be configured by the network, where the UE is expected to receive all the multipaths of a TRS within the delay spread. The maximum reporting time is configured by the network, within which the UE 110 needs to report the Doppler information to the gNB 170. The maximum propagation delay of each TRP-specific TRS is configured by the network. The UE is expected to receive the TRS within the maximum propagation delay.

By introducing validity conditions for the measurement, the quality of Doppler parameter measurements can be guaranteed and ambiguity avoided at the gNB-side as to how measurements are conducted at the UE-side, e.g. by condition#1 such that all configured K dominant multipath components are above a certain power threshold or power offset with respect to the anchor TRS resource (to distinguish from the thermal noise floor) at some specific level for usage of the network (e.g. for Doppler parameter prediction at the network side and indication for the UE). Additionally, by introducing condition#2, Doppler parameter measurement restriction is introduced for the UE such that the UE shall measure and compute over P-consecutive TRS transmission occasions. If this restriction is not introduced, ambiguity remains for the network out of which TRS resources the UE has computed Doppler parameters. The network, such as the RAN node 170 or network element(s) 190, can configure the Doppler (phase/frequency/time) parameter reporting formats, e.g. the format for reporting the one or more Doppler parameters. TRP specific Doppler parameters may include actual Doppler shift values of K_{TRP#} dominant paths from each TRP specific TRS resource or relative (differentially encoded) Doppler shift values with respect to a dominant path TRP specifically. Inter-TRP Doppler parameters may include the Doppler shift difference between K_{TRP#} dominant paths between a reference TRP and anchor TRP resources (the difference can be also differentially encoded). TRP specific phase values may include actual phase values that can be computed for one or more dominant path(s) of each TRS. Inter-TRP t phase values may include a phase difference between the TRP-specific TRS resources that can be computed for the dominant multipath components of each TRP resource. TRP specific time parameters may include an actual arrival time of one or more dominant path component(s) of a TRS resource, and the time difference(s) to the specific multipaths can be computed within the TRS and for each TRP specific TRS resource. Inter-TRP time parameters may include the time differences between the multipath components, which may be calculated based on an anchor TRP-specific TRS resource.

Upon receiving the Doppler configuration frame from the network (associated TRP), the UE can perform the Doppler measurement suitably along with the validity conditions on the receiving DL NZP-CSI-RS signal from each of the TRPs. UE Doppler measurements and the validity conditions are defined as follows.

The validity of TRP specific and inter-TRP Doppler parameter measurements and reporting is defined as follows (for one or more Doppler parameters).

A Doppler parameter can be defined to be as either multi-path specific Doppler shift or a multipath specific Doppler shift difference between resources associated with an “anchor” TRP and another TRP (sharing the same or different physical cell ID (PCI)). In the case of the multipath scenario, the Doppler information can also be reported in the form of a Doppler spectrum, in this regard UE 110 computes the Doppler spectrum with a given bandwidth and frequency resolution. The validity of Doppler parameter measurements can be defined by using at least one of the following conditions (Conditions #s 1-5).

Condition#1, inter-TRP multi-path power difference between K_{TRP#} dominant multi-paths: UE determines K_{TRP#} dominant multi-path components according to associated reference signal received powers (RSRP) associated with a TRP specific TRS resource and order/rank (in descending order) them specifically for the TRP. To define validity of condition #1, all K_{TRP#} dominant multi-path components of each TRP needs to be above a configured power threshold [in dBm/dB], which power threshold may be configured by the network, such as with RAN node 170 or the one or more network element(s) 190. In an alternative implementation, the UE is allowed to select K_{UE} (≥1) dominant components that are above the configured power threshold (K_{UE}≤K_{TRP#}). Otherwise, validity of condition #1 is not valid. In an alternative approach, to define validity of condition #1, all K_{TRP#} dominant multi-path components of each TRP needs to be within maximum D_{power-offset-max} [dB] power offset with respect to the anchor TRP's first (the most dominant) multi-path component. In an alternative implementation, the UE is allowed to select K_{UE} (≥1) dominant components that are D_{power-offset-max} [B] power offset with respect to anchor the configured power threshold (K_{UE}≤K_{TRP#}) . Otherwise, validity of the condition#1 is not valid. When the condition#1 is valid, the UE shall determine the Doppler shift associated with each of the paths and the corresponding Doppler difference between anchor resource and reference resources associated with TRPs. Similarly, the coherent phase of each dominant path of the TRS or coherent phase differences between the TRSs are computed.

Condition#2, TRP specific/inter-TRP TRS resource application time for Doppler difference computation. Validity of condition#2 is defined when a reception time difference between two different DL TRS resources is within a configured time offset D_{time-offset}, e.g., P-consecutive TRS transmission occasions in time, t. When validity between resources holds, the UE determines corresponding Doppler parameters. Otherwise, the measurement is defined as invalid. One potential use case of this condition, when Doppler parameter measurements are performed either between periodic/semi-persistent resources from different TRPs and/or between aperiodic resources from TRPs triggered via single or multi-DCI.

Condition#3, TRP specific/inter-TRP time difference computation to validate/report the estimation time (or age) of the CSI information. Validity condition#3 is defined if the aging information is configured. At least one of the TRS resources from all the configured TRPs arrives within the aging time. In this case UE 110 uses only one TRS resource from each TRP to compute the Doppler shift/spread. Otherwise, this condition is not valid. If UE 110 receives multiple TRS resources pertaining to a single TRP within the predefined aging time, such as in the case of periodic TRS, UE can use multiple TRS resources from each TRP to estimate the Doppler parameters more accurately. The network can configure the aging time interval, for example, as a set of M periods of TRS transmissions, after which the measured information is considered to be no longer coherent. Validity condition#3 is also related to the maximum delay spread of a TRP-specific TRP. If UE 110 receives all the multipaths (with less than or equal to a certain power threshold) within the delay spread then the condition is valid, else the condition is not valid.

Condition#4, UE 110 checks the time of arrival of one or more dominant path(s) of each TRP specific TRS. If the dominant path of a TRP specific TRS arrives later than the maximum propagation delay or delay spread, then the TRS is not valid. In some cases longer propagation delays are not permitted due to inter-symbol interference.

Condition#5, UE keeps track of the reporting time. If UE 110 is unable to send the report within the reporting time, this condition is not valid. This can be the case, if UE did not receive all the TRSs or UE 110 does not have a free resource to send the report in the uplink. After completing the Doppler measurements the UE uses the following reporting method to report the Doppler measurements along with the validity conditions to the network (associated TRP).

The method for Doppler information reporting with the default mode of operation is defined as follows.

Default operation mode and related reporting format: (if all the configured validity conditions are met). The CSI report includes one the following options with corresponding elements: Option A: non-differential reporting, with an L-bit quantized Doppler value and validity bit=1; Option B: differential reporting, with an L-bit quantized Doppler difference value and validity bit=1. The report includes a number of TRP-specific TRS resources used for measurements. Fallback operation mode and related reporting format: (if at least one of the validity conditions is not met), comprising Case-1 or Case-2.

Case-1: UE 110 can report by adding a validity condition to each of the measurements. Either Doppler shift or Doppler difference is reported. Anchor TRS resources are valid or not valid, which may be reported. If an anchor node is selected differently, an indication of the anchor TRS resource may be reported. A validity bit for each path measurement may be reported. A validity bit for each Doppler difference measured may be reported. A validity bit for application time may be reported. A validity bit for aging information may be reported. An indication of a number of TRP-specific TRS resources used for measurements may be reported. Alternatively, to reduce reporting overhead, the report can include only one validity bit to indicate if all measurements are valid or not. In an alternative approach, a bit-vector of length Q (=number of measurements) is defined to indicate whether a measurement is valid (=1) or not (=0). In case-1, the network, such as RAN node 170 or one or more network elements 190, can deduce the number of TRPs involved in the measurements from validity bits.

Case-2: UE 110 can report the parameters by encoding the validity information for measurements. Validity of Doppler differences or Doppler shift measurement may be reported. A number of valid paths measured may be reported. An indication of a number of TRP-specific TRS resources used for measurements may be reported, which can be used for aging information, while the network applies in the DL compensation. An indication of a number of TRPs involved in the measurement may be reported, which can be used with only these TRP for CJT. A validity indication of application time may be reported.

In addition, UE 110 can also reuse the existing beam management CSI report by adding a validity bit or other bit for each measurement, or UE 110 can use the herein described report methods based on the validity conditions.

When configured validity conditions have not been fulfilled at the UE side, a fallback operation is defined, which can provide indication of whether one or more measurements are valid or not (if the one or more measurements are not valid). This can be done by either reserving some extra payload bits for indication of validity of each of the configured measurements (i.e. 0=not valid or 1=valid) or determining some values (e.g. some certain maximum/minimum value) which implicitly indicates the measurement to being valid or invalid (enables use of a single reporting format for reporting valid and invalid measurements).

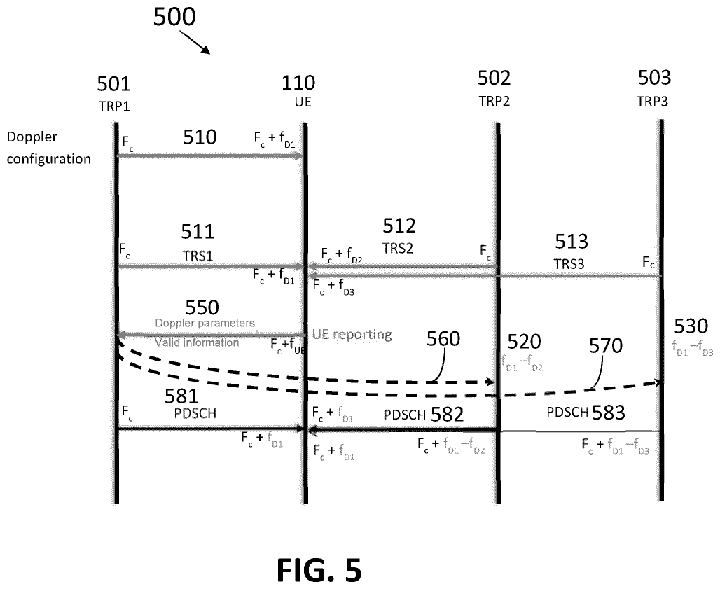

FIG. 5 illustrates an example/method 500 for Doppler information reporting for the LoS case. Assuming UE 110 is associated with TRP1 501, initially TRP1 501 transmits the ‘Doppler configuration’ frame 510 to the UE 110, and this includes the network parameters and conditions to be measured. After that each TRP (501, 502, 503) sends TRS using allocated resources. UE 110 receives the TRS from different TRPs at different frequency offsets based on the associated Doppler.

As shown in FIG. 5, at time F_{c} TRP1 501 transmits TRS1 511 to UE 110, and UE 110 receives TRS1 511 t time F_{c}+f_{D1}. At time F_{c} TRP1 501 transmits TRS1 511 to UE 110, and UE 110 receives TRS1 511 at time F_{c}+f_{D1}. At time F_{c} TRP2 502 transmits TRS2 512 to UE 110, and UE 110 receives TRS2 512 at time F_{c}+f_{D2}. At time F_{c} TRP3 503 transmits TRS3 513 to UE 110, and UE 110 receives TRS3 513 at time F_{c}+f_{D3}.

UE 110 performs the operations indicated by the ‘Doppler configuration’ frame transmitted at 510. In one case the UE 110 is commanded to perform the Doppler differences between TRP1 501 and TRP2 502, and TRP1 501 and TRP3 503 on a single path. In this case, UE 110 calculates the difference in the received frequencies as ‘f_{d1}-f_{d2}’ and ‘f_{d1}-f_{d3}’ (refer to 520 and 530, respectively) and sends this information along with the validity of those measurements at time F_{c}+f_{UE} using UE reporting frame 550 in uplink to the TRP1 501 (associated TRP). This information is shared among the TRPs using backhaul links, and the TRPs pre-compensate for the data as shown in FIG. 5. For example, as shown in FIG. 5, TRP1 501 shares the calculation of ‘f_{d1}-f_{d2}’ (520) with TRP2 502 using backhaul link 560, and TRP1 501 shares the calculation of ‘f_{d1}-f_{d3}’ (530) with TRP3 using backhaul link 570.

At time F_{c}, TRP1 501 transmits PDSCH 581 to UE 110, which is received by UE 110 at time F_{c}+f_{D1}. At time F_{c}+f_{D1}-f_{D2}, TRP2 502 transmits PDSCH 582 to UE 110, which is received by UE 110 at time F_{c}+f_{D1}. At time F_{c}+f_{D1}-f_{D3}, TRP3 503 transmits PDSCH 583 to UE 110, which is received by UE 110 at time F_{c}+f_{D1}.

The above defined Doppler parameter estimation and reporting method has the following benefits and technical effects. The method reduces the UL SRS overhead to be used for Doppler measurements, and provides the enhanced CSI measurement report for a moving UE. The Doppler parameters are more accurate and reliable. Network efficiency is improved by utilizing the Doppler information for any of the use cases mentioned in [Tdoc number R1-2203229—‘New WID: On CSI enhancements for Rel-18 NR MIMO evolution’R3]. Further, the examples described herein may be relevant in the context of the Rel-18 work item for MIMO Evolution for downlink and uplink.

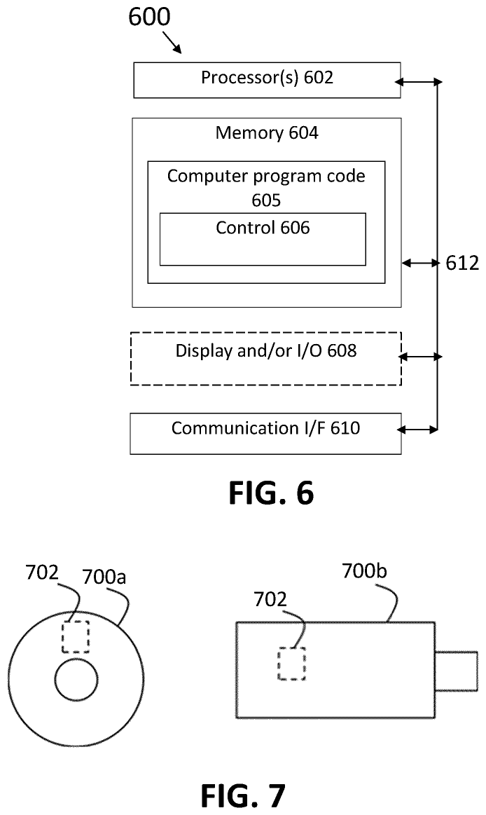

FIG. 6 is an example apparatus 600, which may be implemented in hardware, configured to implement the examples described herein. The apparatus 600 comprises at least one processor 602 (e.g. an FPGA and/or CPU), at least one memory 604 including computer program code 605, wherein the at least one memory 604 and the computer program code 605 are configured to, with the at least one processor 602, cause the apparatus 600 to implement circuitry, a process, component, module, or function (collectively control 606) to implement the examples described herein, including confidence-based advanced trajectory prediction. The memory 604 may be a non-transitory memory, a transitory memory, a volatile memory (e.g. RAM), or a non-volatile memory (e.g. ROM).

The apparatus 600 optionally includes a display and/or I/O interface 608 that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 600 includes one or more communication e.g. network (N/W) interfaces (I/F(s)) 610. The communication I/F(s) 610 may be wired and/or wireless and communicate over the Internet/other network(s) via any communication technique. The communication I/F(s) 610 may comprise one or more transmitters and one or more receivers. The communication I/F(s) 610 may comprise standard well-known components such as an amplifier, filter, frequency-converter, (de)modulator, and encoder/decoder circuitries and one or more antennas.

The apparatus 600 to implement the functionality of control 606 may be UE 110, RAN node 170 (e.g. gNB), or network element(s) 190, as well as any of the TRPs depicted in FIG. 4 and FIG. 5. Thus, processor 602 may correspond to processor(s) 120, processor(s) 152 and/or processor(s) 175, memory 604 may correspond to memory(ies) 125, memory(ies) 155 and/or memory(ies) 171, computer program code 605 may correspond to computer program code 123, module 140-1, module 140-2, and/or computer program code 153, module 150-1, module 150-2, and/or computer program code 173 or module 177, and communication I/F(s) 610 may correspond to transceiver 130, antenna(s) 128, transceiver 160, antenna(s) 158, N/W I/F(s) 161, and/or N/W I/F(s) 180. Alternatively, apparatus 600 may not correspond to either of UE 110, RAN node 170, network element(s) 190, or the TRPs depicted in FIG. 4 and FIG. 5, as e.g. apparatus 600 may be part of a self-organizing/optimizing network (SON) node, such as in a cloud.

The apparatus 600 may also be distributed throughout the network (e.g. 100) including within and between apparatus 600 and any network element (such as a network control element (NCE) 190 and/or the RAN node 170 and/or the UE 110, and/or any of the TRPs depicted in FIG. 4 and FIG. 5).

Interface 612 enables data communication between the various items of apparatus 600, as shown in FIG. 6. For example, the interface 612 may be one or more buses such as address, data, or control buses, and may include any interconnection mechanism, such as a series of lines on a motherboard or integrated circuit, fiber optics or other optical communication equipment, and the like. Computer program code 605, including control 606 may comprise object-oriented software configured to pass data/messages between objects within computer program code 605. The apparatus 600 need not comprise each of the features mentioned, or may comprise other features as well.

FIG. 7 shows a schematic representation of non-volatile memory media 700a (e.g. computer disc (CD) or digital versatile disc (DVD)) and 700b (e.g. universal serial bus (USB) memory stick) storing instructions and/or parameters 702 which when executed by a processor allows the processor to perform one or more of the steps of the methods described previously.

It is to be noted that example embodiments may be implemented as circuitry, in software, hardware, application logic or a combination of software, hardware and application logic. In an example embodiment, the application logic, software or an instruction set is maintained on any computer-readable media. In the context of this disclosure, a “computer-readable medium” may be any media or means that can contain, store, communicate, propagate or transport the instructions for use by or in connection with an instruction execution system, apparatus, or device, such as the base stations, TRPs, network nodes, or user equipment of the above-described example embodiments.

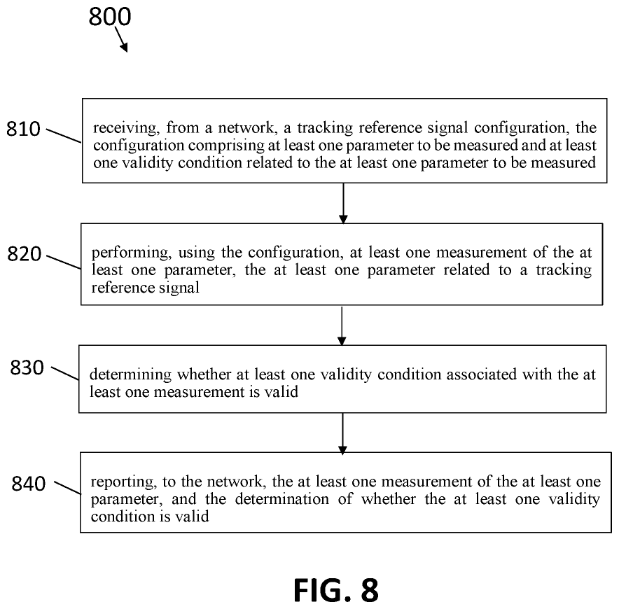

FIG. 8 is an example method 800. At 810, the method includes receiving, from a network, a tracking reference signal configuration, the configuration comprising at least one parameter to be measured and at least one validity condition related to the at least one parameter to be measured. At 820, the method includes performing, using the configuration, at least one measurement of the at least one parameter, the at least one parameter related to a tracking reference signal. At 830, the method includes determining whether at least one validity condition associated with the at least one measurement is valid. At 840, the method includes reporting, to the network, the at least one measurement of the at least one parameter, and the determination of whether the at least one validity condition is valid. Method 800 may be performed with a user equipment (e.g. UE 110).

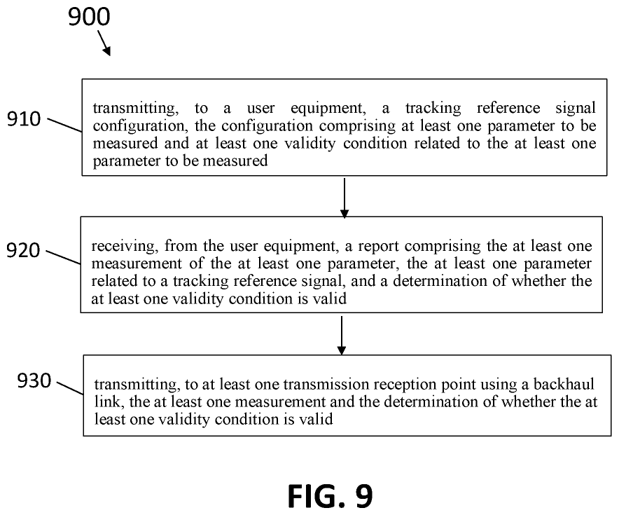

FIG. 9 is an example method 900. At 910, the method includes transmitting, to a user equipment, a tracking reference signal configuration, the configuration comprising at least one parameter to be measured and at least one validity condition related to the at least one parameter to be measured. At 920, the method includes receiving, from the user equipment, a report comprising the at least one measurement of the at least one parameter, the at least one parameter related to a tracking reference signal, and a determination of whether the at least one validity condition is valid. At 930, the method includes transmitting, to at least one transmission reception point using a backhaul link, the at least one measurement and the determination of whether the at least one validity condition is valid. Method 900 may be performed with a network node (e.g. RAN node 170 or network element(s) 190).

The following examples (1-25) are provided and described herein.

Example 1. An apparatus comprising: means for receiving, from a network, a tracking reference signal configuration, the configuration comprising at least one parameter to be measured and at least one validity condition related to the at least one parameter to be measured; means for performing, using the configuration, at least one measurement of the at least one parameter, the at least one parameter related to a tracking reference signal; means for determining whether at least one validity condition associated with the at least one measurement is valid; and means for reporting, to the network, the at least one measurement of the at least one parameter, and the determination of whether the at least one validity condition is valid.

Example 2. The apparatus of example 1, wherein the configuration comprises an indication of at least one resource comprising an anchor resource used in a Doppler information computation, the anchor resource associated with an anchor transmission reception point.

Example 3. The apparatus of example 2, wherein the Doppler information computation comprises at least one of: a multipath Doppler shift; a multipath Doppler shift difference between the anchor resource associated with the anchor transmission reception point and a resource associated with another transmission reception point; a Doppler frequency difference; a relative signal time difference; or a time difference of arrival.

Example 4. The apparatus of any of examples 1 to 3, wherein the at least one parameter comprises multipath Doppler information.

Example 5. The apparatus of example 4, wherein the Doppler information comprises at least one of: a multipath Doppler shift; a multipath Doppler shift difference between the anchor resource associated with the anchor transmission reception point and a resource associated with another transmission reception point; a Doppler frequency; a Doppler spectrum; a quantized Doppler value having a number of bits; or a quantized Doppler difference value having a number of bits.

Example 6. The apparatus of any of examples 1 to 5, wherein the at least one validity condition is based on a transmission reception point (TRP)-specific or inter-TRP multi-path power difference between a number of one or more dominant multi-path components.

Example 7. The apparatus of any of examples 1 to 6, wherein the at least one validity condition is based on a transmission reception point (TRP)-specific or inter-TRP tracking reference signal resource application time for Doppler difference computation.

Example 8. The apparatus of any of examples 1 to 7, wherein the at least one validity condition is based on a transmission reception point (TRP)-specific or inter-TRP difference in measurement time for Doppler difference computation.

Example 9. The apparatus of any of examples 1 to 8, wherein the at least one validity condition is based on a time of arrival computation of a transmission reception point (TRP)-specific tracking reference signal.

Example 10. The apparatus of any of examples 1 to 9, wherein the at least one validity condition is based on a reporting time offset.

Example 11. The apparatus of any of examples 1 to 10, wherein the reporting of the determination of whether the at least one validity condition is valid comprises a default mode for when the at least one validity condition is valid.

Example 12. The apparatus of any of examples 1 to 11, wherein the reporting of the determination of whether the at least one validity condition is valid comprises a fallback mode for when at least one of the at least one validity condition is not valid.

Example 13. An apparatus comprising: means for transmitting, to a user equipment, a tracking reference signal configuration, the configuration comprising at least one parameter to be measured and at least one validity condition related to the at least one parameter to be measured; means for receiving, from the user equipment, a report comprising the at least one measurement of the at least one parameter, the at least one parameter related to a tracking reference signal, and a determination of whether the at least one validity condition is valid; and means for transmitting, to at least one transmission reception point using a backhaul link, the at least one measurement and the determination of whether the at least one validity condition is valid.

Example 14. The apparatus of example 13, wherein the configuration comprises an indication of at least one resource comprising an anchor resource used in a Doppler information computation, the anchor resource associated with an anchor transmission reception point.

Example 15. The apparatus of example 14, wherein the Doppler information computation comprises at least one of: a multipath Doppler shift; a multipath Doppler shift difference between the anchor resource associated with the anchor transmission reception point and a resource associated with another transmission reception point; a Doppler frequency difference; a relative signal time difference; or a time difference of arrival.

Example 16. The apparatus of any of examples 13 to 15, wherein the at least one parameter comprises a multipath Doppler information.

Example 17. The apparatus of example 16, wherein the Doppler information comprises at least one of: a multipath Doppler shift; a multipath Doppler shift difference between the anchor resource associated with the anchor transmission reception point and a resource associated with another transmission reception point; a Doppler frequency; a Doppler spectrum; a quantized Doppler value having a number of bits; or a quantized Doppler difference value having a number of bits.

Example 18. The apparatus of any of examples 13 to 17, wherein the at least one validity condition is based on at least one of: a transmission reception point (TRP) specific or inter-TRP multi-path power difference between a number of one or more dominant multi-path components; a TRP-specific or inter-TRP tracking reference signal resource application time for Doppler difference computation; a TRP-specific or inter-TRP difference in measurement time for Doppler difference computation; a time of arrival computation of a TRP specific tracking reference signal; or a reporting time offset.

Example 19. The apparatus of any of examples 13 to 18, wherein the reporting of the determination of whether the at least one validity condition is valid comprises a default mode and a fallback mode, the default mode being for when the at least one validity condition is valid, and the fallback mode being for when at least one of the at least one validity condition is not valid.

Example 20. An apparatus comprising: at least one processor; and at least one memory including computer program code; wherein the at least one memory and the computer program code are configured to, with the at least one processor, cause the apparatus at least to: receive, from a network, a tracking reference signal configuration, the configuration comprising at least one parameter to be measured and at least one validity condition related to the at least one parameter to be measured; perform, using the configuration, at least one measurement of the at least one parameter, the at least one parameter related to a tracking reference signal; determine whether at least one validity condition associated with the at least one measurement is valid; and report, to the network, the at least one measurement of the at least one parameter, and the determination of whether the at least one validity condition is valid.

Example 21. An apparatus comprising: at least one processor; and at least one memory including computer program code; wherein the at least one memory and the computer program code are configured to, with the at least one processor, cause the apparatus at least to: transmit, to a user equipment, a tracking reference signal configuration, the configuration comprising at least one parameter to be measured and at least one validity condition related to the at least one parameter to be measured; receive, from the user equipment, a report comprising the at least one measurement of the at least one parameter, the at least one parameter related to a tracking reference signal, and a determination of whether the at least one validity condition is valid; and transmit, to at least one transmission reception point using a backhaul link, the at least one measurement and the determination of whether the at least one validity condition is valid.

Example 22. A non-transitory program storage device readable by a machine, tangibly embodying a program of instructions executable with the machine for performing operations, the operations comprising: receiving, from a network, a tracking reference signal configuration, the configuration comprising at least one parameter to be measured and at least one validity condition related to the at least one parameter to be measured; performing, using the configuration, at least one measurement of the at least one parameter, the at least one parameter related to a tracking reference signal; determining whether at least one validity condition associated with the at least one measurement is valid; and reporting, to the network, the at least one measurement of the at least one parameter, and the determination of whether the at least one validity condition is valid.

Example 23. A non-transitory program storage device readable by a machine, tangibly embodying a program of instructions executable with the machine for performing operations, the operations comprising: transmitting, to a user equipment, a tracking reference signal configuration, the configuration comprising at least one parameter to be measured and at least one validity condition related to the at least one parameter to be measured; receiving, from the user equipment, a report comprising the at least one measurement of the at least one parameter, the at least one parameter related to a tracking reference signal, and a determination of whether the at least one validity condition is valid; and transmitting, to at least one transmission reception point using a backhaul link, the at least one measurement and the determination of whether the at least one validity condition is valid.

Example 24. A method comprising: receiving, from a network, a tracking reference signal configuration, the configuration comprising at least one parameter to be measured and at least one validity condition related to the at least one parameter to be measured; performing, using the configuration, at least one measurement of the at least one parameter, the at least one parameter related to a tracking reference signal; determining whether at least one validity condition associated with the at least one measurement is valid; and reporting, to the network, the at least one measurement of the at least one parameter, and the determination of whether the at least one validity condition is valid.

Example 25. The method of example 24, wherein the configuration comprises an indication of at least one resource comprising an anchor resource used in a Doppler information computation, the anchor resource associated with an anchor transmission reception point.

Example 26. The method of example 25, wherein the Doppler information computation comprises at least one of: a multipath Doppler shift; a multipath Doppler shift difference between the anchor resource associated with the anchor transmission reception point and a resource associated with another transmission reception point; a Doppler frequency difference; a relative signal time difference; or a time difference of arrival.

Example 27. The method of any of examples 24 to 26, wherein the at least one parameter comprises multipath Doppler information.

Example 28. The method of example 27, wherein the Doppler information comprises at least one of: a multipath Doppler shift; a multipath Doppler shift difference between the anchor resource associated with the anchor transmission reception point and a resource associated with another transmission reception point; a Doppler frequency; a Doppler spectrum; a quantized Doppler value having a number of bits; or a quantized Doppler difference value having a number of bits.

Example 29. The method of any of examples 24 to 28, wherein the at least one validity condition is based on a transmission reception point (TRP)-specific or inter-TRP multi-path power difference between a number of one or more dominant multi-path components.

Example 30. The method of any of examples 24 to 29, wherein the at least one validity condition is based on a transmission reception point (TRP)-specific or inter-TRP tracking reference signal resource application time for Doppler difference computation.

Example 31. The method of any of examples 24 to 30, wherein the at least one validity condition is based on a transmission reception point (TRP)-specific or inter-TRP difference in measurement time for Doppler difference computation.

Example 32. The method of any of examples 24 to 31, wherein the at least one validity condition is based on a time of arrival computation of a transmission reception point (TRP)-specific tracking reference signal.

Example 33. The method of any of examples 24 to 32, wherein the at least one validity condition is based on a reporting time offset.

Example 34. The method of any of examples 24 to 33, wherein the reporting of the determination of whether the at least one validity condition is valid comprises a default mode for when the at least one validity condition is valid.

Example 35. The method of any of examples 24 to 34, wherein the reporting of the determination of whether the at least one validity condition is valid comprises a fallback mode for when at least one of the at least one validity condition is not valid.

Example 36. A method comprising: transmitting, to a user equipment, a tracking reference signal configuration, the configuration comprising at least one parameter to be measured and at least one validity condition related to the at least one parameter to be measured; receiving, from the user equipment, a report comprising the at least one measurement of the at least one parameter, the at least one parameter related to a tracking reference signal, and a determination of whether the at least one validity condition is valid; and transmitting, to at least one transmission reception point using a backhaul link, the at least one measurement and the determination of whether the at least one validity condition is valid.

Example 37. The method of example 36, wherein the configuration comprises an indication of at least one resource comprising an anchor resource used in a Doppler information computation, the anchor resource associated with an anchor transmission reception point.

Example 38. The method of example 37, wherein the Doppler information computation comprises at least one of: a multipath Doppler shift; a multipath Doppler shift difference between the anchor resource associated with the anchor transmission reception point and a resource associated with another transmission reception point; a Doppler frequency difference; a relative signal time difference; or a time difference of arrival.
Example 39. The method of any of examples 36 to 38, wherein the at least one parameter comprises a multipath Doppler information.

Example 40. The method of example 39, wherein the Doppler information comprises at least one of: a multipath Doppler shift; a multipath Doppler shift difference between the anchor resource associated with the anchor transmission reception point and a resource associated with another transmission reception point; a Doppler frequency; a Doppler spectrum; a quantized Doppler value having a number of bits; or a quantized Doppler difference value having a number of bits.

Example 41. The method of any of examples 36 to 40, wherein the at least one validity condition is based on at least one of: a transmission reception point (TRP) specific or inter-TRP multi-path power difference between a number of one or more dominant multi-path components; a TRP-specific or inter-TRP tracking reference signal resource application time for Doppler difference computation; a TRP-specific or inter-TRP difference in measurement time for Doppler difference computation; a time of arrival computation of a TRP specific tracking reference signal; or a reporting time offset.

Example 42. The method of any of examples 36 to 41, wherein the reporting of the determination of whether the at least one validity condition is valid comprises a default mode and a fallback mode, the default mode being for when the at least one validity condition is valid, and the fallback mode being for when at least one of the at least one validity condition is not valid.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific integrated circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memory(ies) as described herein may be implemented using any suitable data storage technology, such as semiconductor based memory devices, flash memory, magnetic memory devices and systems, optical memory devices and systems, non-transitory memory, transitory memory, fixed memory and removable memory. The memory(ies) may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In the figures, arrows between individual blocks represent operational couplings there-between as well as the direction of data flows on those couplings.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are defined as follows (the abbreviations and acronyms may be appended with each other or with other characters using e.g. a dash or hyphen):
4G fourth generation
5G fifth generation
5GC 5G core network
AI artificial intelligence
AMF access and mobility management function
AP aperiodic
ASIC application-specific integrated circuit
BW bandwidth
CJT coherent joint transmission
COMP coordinated multipoint
CP cyclic prefix
CP-OFDM cyclic prefix orthogonal frequency division multiplexing
CPU central processing unit
CSI channel state/status information
CU central unit or centralized unit
DCI downlink control information
DL downlink
DMRS or DM-RS demodulation reference signal
DSP digital signal processor
DU distributed unit
eNB evolved Node B (e.g., an LTE base station)
EN-DC E-UTRAN new radio-dual connectivity
en-gNB node providing NR user plane and control plane protocol terminations towards the UE, and acting as a secondary node in EN-DC
E-UTRA evolved universal terrestrial radio access, i.e., the LTE radio access technology
E-UTRAN E-UTRA network
F1 interface between the CU and the DU
FDD frequency division duplex
FPGA field-programmable gate array
FR frequency range
gNB base station for 5G/NR, i.e., a node providing NR user plane and control plane protocol terminations towards the UE, and connected via the NG interface to the 5GC
HST high speed train
IAB integrated access and backhaul
ID identifier
I/F interface
JT joint transmission
I/O input/output
L-bit L number of bits
LMF location management function
LoS line of sight
LTE long term evolution (4G)
MAC medium access control
max maximum
MCS modulation and coding scheme
M-IDFT inverse discrete Fourier transform of size M
MIMO multiple-input multiple-output
ML machine learning
MME mobility management entity
MRO mobility robustness optimization
mTRP multiple TRP
MU multi-user
NCE network control element
NCJT or NC-JT non-coherent joint transmission
ng or NG new generation
ng-eNB new generation eNB
NG-RAN new generation radio access network
NR new radio (5G)
N/W network
NZP non-zero power
OFDM orthogonal frequency division multiplexing
P number of e.g. P-consecutive TRS transmission occasions
PCI physical cell identifier
PDA personal digital assistant
PDCP packet data convergence protocol
PDSCH physical downlink shared channel
PHY physical layer
PRB physical resource block
pre-comp pre-compensation
PUSCH physical uplink shared channel
P/SP periodic or semi-persistent
Q length of bit vector
QCL quasi co-location
R1 radio layer 1
RAM random access memory
RAN radio access network
Rel- release
RIC RAN intelligent controller
RLC radio link control
ROM read-only memory
RP RAN meeting
RRC radio resource control (protocol)
RRH remote radio head
RS reference signal
RSRP reference signal received power
RU radio unit
Rx or RX receiver or reception
SDAP service data adaption protocol
SFN single frequency network
SGW serving gateway
SINR signal to interference noise ratio
SMF session management function
SON self-organizing/optimizing network
SP semi-persistent
SRS sounding reference signal
SSB synchronization signal block
STRP single TRP
TCI transmission configuration indication
TDD time-division duplex
Tdoc technical document
TRP transmission reception point
trs or TRS tracking reference signal
TS technical specification
Tx or TX transmitter or transmission
Type I conventional dual codebook structure for CSI feedback
Type II feedback targeting high-resolution CSI acquisition for multi-user multiple-input-and-multiple-output (MU-MIMO) operations
UAV unmanned aerial vehicle
UE user equipment (e.g., a wireless, typically mobile device)
UL uplink
UPF user plane function
URLLC ultra-reliable low latency communications
WID work item description
X2 network interface between RAN nodes and between RAN and the core network
Xn network interface between NG-RAN nodes

1.-15. (canceled)

16. An apparatus comprising:
a processor; and
a memory comprising computer-executable instructions that, when executed by the processor, cause the processor to perform the following operations:
receiving, from a network, a reference signal configuration, the reference signal configuration comprising at least one parameter to be measured and at least one validity condition related to the at least one parameter to be measured, wherein the configuration comprises an indication of at least one resource comprising an anchor resource used in a Doppler information computation, the anchor resource associated with an anchor transmission reception point, wherein the Doppler information computation comprises:
a multipath Doppler shift;
a multipath Doppler shift difference between the anchor resource associated with the anchor transmission reception point and a resource associated with another transmission reception point;
a Doppler frequency difference;
a relative signal time difference;
a time difference of arrival;
a quantized Doppler value having a number of bits; and
a quantized Doppler difference value having a number of bits;
performing, using the reference signal configuration, at least one measurement of the at least one parameter, the at least one parameter related to a tracking reference signal;
determining whether at least one validity condition associated with the at least one measurement is valid; and
reporting, to the network, the at least one measurement of the at least one parameter, and the determination of whether the at least one validity condition is valid.

17. The apparatus of claim 16, wherein the at least one parameter comprises multipath Doppler information.

18. The apparatus of claim 17, wherein the at least one validity condition is based on a transmission reception point (TRP)-specific or inter-TRP multi-path power difference between a number of one or more dominant multi-path components.

19. The apparatus of claim 17, wherein the at least one validity condition is based on a transmission reception point (TRP)-specific or inter-TRP tracking reference signal resource application time for Doppler difference computation.

20. The apparatus of claim 17, wherein the at least one validity condition is based on a transmission reception point (TRP)-specific or inter-TRP difference in measurement time for Doppler difference computation.

21. The apparatus of claim 17, wherein the at least one validity condition is based on a time of arrival computation of a transmission reception point (TRP)-specific tracking reference signal.

22. The apparatus of claim 17, wherein the at least one validity condition is based on a reporting time offset.

23. The apparatus of claim 22, wherein the reporting of the determination of whether the at least one validity condition is valid comprises a default mode for when the at least one validity condition is valid.

24. The apparatus of claim 22, wherein the reporting of the determination of whether the at least one validity condition is valid comprises a fallback mode for when at least one of the at least one validity condition is not valid.

25. A system comprising:
an apparatus;
a processor; and
a memory comprising computer-executable instructions that, when executed by the processor, cause the processor to perform the following operations:
receiving, from a network, a reference signal configuration, the reference signal configuration comprising at least one parameter to be measured and at least one validity condition related to the at least one parameter to be measured, wherein the configuration comprises an indication of at least one resource comprising an anchor resource used in a Doppler information computation, the anchor resource associated with an anchor transmission reception point, wherein the Doppler information computation comprises:
a multipath Doppler shift;
a multipath Doppler shift difference between the anchor resource associated with the anchor transmission reception point and a resource associated with another transmission reception point;
a Doppler frequency difference;
a relative signal time difference;
a time difference of arrival;
a quantized Doppler value having a number of bits; and
a quantized Doppler difference value having a number of bits;
performing, using the reference signal configuration, at least one measurement of the at least one parameter, the at least one parameter related to a tracking reference signal;
determining whether at least one validity condition associated with the at least one measurement is valid; and
reporting, to the network, the at least one measurement of the at least one parameter, and the determination of whether the at least one validity condition is valid.

26. The apparatus of claim 25, wherein the at least one parameter comprises multipath Doppler information.

27. The apparatus of claim 26, wherein the at least one validity condition is based on a transmission reception point (TRP)-specific or inter-TRP multi-path power difference between a number of one or more dominant multi-path components.

28. The apparatus of claim 27, wherein the reporting of the determination of whether the at least one validity condition is valid comprises a default mode for when the at least one validity condition is valid.

29. The apparatus of claim 27, wherein the reporting of the determination of whether the at least one validity condition is valid comprises a fallback mode for when at least one of the at least one validity condition is not valid.

30. The apparatus of claim 26, wherein the at least one validity condition is based on a transmission reception point (TRP)-specific or inter-TRP tracking reference signal resource application time for Doppler difference computation.

31. The apparatus of claim 26, wherein the at least one validity condition is based on a transmission reception point (TRP)-specific or inter-TRP difference in measurement time for Doppler difference computation.

32. The apparatus of claim 26, wherein the at least one validity condition is based on a time of arrival computation of a transmission reception point (TRP)-specific tracking reference signal.

33. The apparatus of claim 26, wherein the at least one validity condition is based on a reporting time offset.

34. A method comprising:
receiving, from a network, a reference signal configuration, the reference signal configuration comprising at least one parameter to be measured and at least one validity condition related to the at least one parameter to be measured, wherein the configuration comprises an indication of at least one resource comprising an anchor resource used in a Doppler information computation, the anchor resource associated with an anchor transmission reception point, wherein the Doppler information computation comprises:
a multipath Doppler shift;
a multipath Doppler shift difference between the anchor resource associated with the anchor transmission reception point and a resource associated with another transmission reception point;
a Doppler frequency difference;
a relative signal time difference;
a time difference of arrival;
a quantized Doppler value having a number of bits; and
a quantized Doppler difference value having a number of bits;
performing, using the reference signal configuration, at least one measurement of the at least one parameter, the at least one parameter related to a tracking reference signal;
determining whether at least one validity condition associated with the at least one measurement is valid; and
reporting, to the network, the at least one measurement of the at least one parameter, and the determination of whether the at least one validity condition is valid.

35. The method of claim 34, wherein the at least one validity condition is based on a transmission reception point (TRP)-specific or inter-TRP multi-path power difference between a number of one or more dominant multi-path components.
